(19) United States
(12) Patent Application Publication
(10) Pub. No.: US 2020/0183437 A1
(43) Pub. Date: Jun. 11, 2020

(54) Dynamic Power Factor Correction On Cross-Referenced Network Identified Devices

(71) Applicant: Comcast Cable Communications, LLC, Philadelphia, PA (US)

(72) Inventors: Adam Eng, Golden, CO (US); Jose Lopez, Denver, CO (US)

(21) Appl. No.: 16/212,092

(22) Filed: Dec. 6, 2018

(51) Int. Cl. G05F 1/70; H04L 12/24; G05F 1/625; G06F 1/3203; H04L 29/12

(52) U.S. Cl. CPC G05F 1/70; H04L 41/0213; H04L 61/6022; G06F 1/3203; G05F 1/625

(57) ABSTRACT

Systems and methods are described for power management. A device may send an indication of an operating mode. The device may comprise a household appliance or other electronic device. A power load associated with the operating mode of the device may be determined based on the operating mode and system information associated with the device. The operating mode may indicate whether the device is going online or entering a mode requiring an increased or decreased power load. The system information may indicate operating mode data comprising power load data and information to enable power factor correction of the system. An instruction to cause an allocation of power from a power source may be sent. The power source may comprise a capacitor bank or battery to allocate power to the system. The power allocated to the system may enable power factor correction of the system and improve efficiency in the system.

### BACKGROUND

Electronic devices such as household appliances may have variable inductive loads requiring dynamic power factor correction (PFC). Conventional power factor controllers that are designed for current monitoring and triggering of capacitors in order to perform dynamic PFC are typically very expensive because they actively monitor inductance on a breaker. Other conventional power factor controllers are too simple and as a result require manual user interaction to set the PFC. These and other shortcomings are addressed in the present disclosure.

### SUMMARY

Systems and methods are described for power management. A device may send an indication of an operating mode. The device may comprise a household appliance or other electronic device. A power load associated with the operating mode of the device may be determined. The power load may be determined based on the operating mode and system information associated with the device. The operating mode may indicate whether the device is going online or entering a mode requiring an increased or decreased power load. The system information may indicate operating mode data associated with the operating mode. The system information may be stored. The operating mode data may comprise power load data and information to enable power factor correction of the system. An instruction to cause an allocation of power from a power source may be sent. The instruction may be sent to a device that allocates power in a power management system. The power source may comprise a capacitor bank or battery to allocate power to the system. The power allocated to the system may enable power factor correction of the system and improve efficiency in the system.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows an example system;

FIG. 3 shows an example power triangle;

FIG. 4 shows an example system;

FIG. 5 shows an example method;

FIG. 6 shows an example method;

FIG. 7 shows an example method; and

FIG. 8 shows an example operating environment.

### DETAILED DESCRIPTION OF ILLUSTRATIVE EMBODIMENTS

Systems and methods are described for power management. Power management may be implemented using a power management system. The power management system may be configured to determine a power load of a device before the device powers on or changes operating mode. A signal comprising an indication of an operating mode of the device may be received. A power load associated with the operating mode of the device may be determined. The power load may be determined based on the operating mode and system information associated with the device. The operating mode may indicate whether the device is going online or requiring an increased or decreased power load. The system information may indicate operating mode data associated with the operating mode. The system information may be stored. The system information may be stored, for example, in memory storage, a database, or in remote or cloud storage. The operating mode data may comprise power load data and information to enable power factor correction of the system. An instruction to cause an allocation of power from a power source may be sent. The instruction may be sent to a power management device that allocates power as needed in the power management system. The power source may comprise a capacitor bank to allocate capacitance to the system. The power source may comprise a battery to allocate power to the system.

For example, before a refrigerator compressor comes on, the refrigerator may send a signal to the system indicating the operating mode of the refrigerator. The operating mode may indicate that the compressor of the refrigerator is powering on. The system may determine whether extra power is needed and may allocate sufficient power. The system may determine whether the power load exceeds a threshold. If the power load exceeds the threshold, the system may allocate power as needed from a power source.

The device receiving the allocation of power may comprise a smart device that has network connectivity enabling the device to send and receive messages via a network. The device may be connected to a network, such as an in-home wireless local area network (WLAN), enabling the system to determine whether the device is on and the operating mode status of the device. The device may comprise an in-home smart appliance such as an air-conditioner, refrigerator, electric stove, dishwasher, oven, microwave, washing machine, or dryer. These devices may comprise high inductive loads based on their motors generating alternating magnetic fields and consuming alternating current (AC). These high inductive loads result in reactive power in the system. Reactive power, measured in volt-ampere reactive (VAR), does not contribute work output to the system. Accordingly, high reactive power in a system decreases the efficiency of the system.

Power factor is the ratio between the useful or true power (P) measured in watts or kilowatts (kW) to the total or apparent power measured in kilovolt-amperes (kVA) that is consumed by an item of AC electrical equipment. Power factor indicates how efficiently electrical power is converted into useful work output. Reactive power reduces the true power in the system and accordingly reduces the power factor of the system.

The power management device in the system may comprise a power source. The power management device may comprise a unit with multiple relays to the power source. The power source may comprise a battery to allocate power to the system. The power source may comprise a capacitor bank that may add capacitance to a system. The capacitor bank may comprise capacitors in parallel or in series. Capacitors store energy that can be allocated to a device or system. The power added to a system from a capacitor bank performs power factor correction (PFC) by reducing the reactive power in the system, and as a result, increases the power factor of the system and therefore increases the efficiency of the system.

While home users are only charged for true power monitored by their meters, industrial users of power are usually charged additional fees for low power factors. The capacitor bank of the power management device may receive, from a computing device, gateway, or user device, instructions to activate capacitors in the capacitor bank in order to reduce reactive power in the system caused by operation of a device such as an appliance. Broadband over power lines (BPL) communications may be used to ensure that the correct power source is allocated to the device. The BPL communications may identify which power leg the device is on and determine the correct power source and relay to activate in order to allocate power to the device.

Control and activation of capacitors to dynamically reduce reactive power, as described herein, is much more cost effective than performing power analysis such as active monitoring and calculating the inductance of the inductive loads in the system. Control and activation of capacitors to dynamically reduce reactive power also greatly reduces the actual power required to support the devices in a system. For example, the actual power required to support a lab or server farm may be greatly reduced. Control and activation of capacitors to dynamically reduce reactive power, as described herein, may reduce power demands from a power plant or other power provider.

The power management device may be a separate device or may be embedded within the computing device or gateway that communicates with each device in the system via the network. The computing device, gateway, or user device may identify each device in the system and may retrieve system information for the device. The computing device, gateway, or user device may retrieve, from the system information, operating mode data (e.g., power load data or inductances) associated with the operating mode of the device. Based on the operating mode data, the computing device, gateway, or user device may send an instruction to the power management device to allocate power from the power source to reduce reactive power in the system. The power source may control and activate capacitors to dynamically reduce the reactive power in the system. As a result, capacitance may be dynamically added to the system based on device identification, operating mode identification, and data analysis, instead of a more costly active power analysis.

The system information may be stored. The system information for a plurality of devices operating in a system may be stored. The system information may be stored, for example, in memory storage, a database, or in remote or cloud storage. The stored system information for the devices may comprise the operating mode data of the devices at various modes of operation. The operating mode data of the devices may comprise the power load data of the devices at various modes of operation. The operating mode data of the devices may comprise the inductances of the devices at various modes of operation. The operating mode data of the devices may comprise capacitances required to perform PFC at various modes of operation.

The system information may be received from a server via the Internet and stored in the computing device, gateway, or user device. For example, the received system information may be stored in memory storage, a database, or in remote or cloud storage. Alternatively or additionally, the system information may be generated by the computing device, gateway, or user device and stored in the computing device, gateway, or user device. For example, the generated system information may be stored in memory storage, a database, or in remote or cloud storage. The devices in the system may be identified by an identifier such as their medium access control (MAC) address. The Institute of Electrical and Electronics Engineers (IEEE) assigns Organizational Unique Identifiers (OUIs) to vendors. The OUIs may comprise the first 24 bits of a MAC address for a device, and the OUI may indicate a specific vendor for that device. The last 24 bits of the MAC address may comprise the unique serial number of the device as assigned to the device by the manufacturer.

When the computing device, gateway, or user device receives a message from the device indicating its operating mode, the computing device, gateway, or user device may retrieve operating mode data associated with the device from the stored system information based on the MAC address of the device. The computing device, gateway, or user device may receive the message from the device indicating its operating mode in response to a status request message sent by the computing device, gateway, or user device. The computing device, gateway, or user device may use the MAC address of the devices in the system to identify the device type of the device (e.g., a type of device manufactured by a specific vendor) and retrieve, from the stored system information, the stored operating mode data of the device type at the operating mode indicated in the status request response. The operating mode data may comprise power load data, inductances, or capacitances for the device type to enable power factor correction.

The computing device, gateway, or user device may execute an application providing a management information base (MIB) browser enabling the computing device, gateway, or user device to issue simple network management protocol (SNMP) messages to the devices in the system. The SNMP messages may request operating mode status from the devices in the system. The MIB defines the type of information available to retrieve from the devices in the system. For example, the device may provide data such as a name, an object identifier (OID), MIB, syntax, access, operating status, and a description of the device. The computing device, gateway, or user device may send SNMP requests to retrieve data from the device such as the operating mode of the device. The computing device, gateway, or user device may send instructions to the power management device to allocate power from the power source based on the operating mode data (e.g. power load data, inductances, or capacitances) that is indicated in the stored system information for the operating mode of the device.

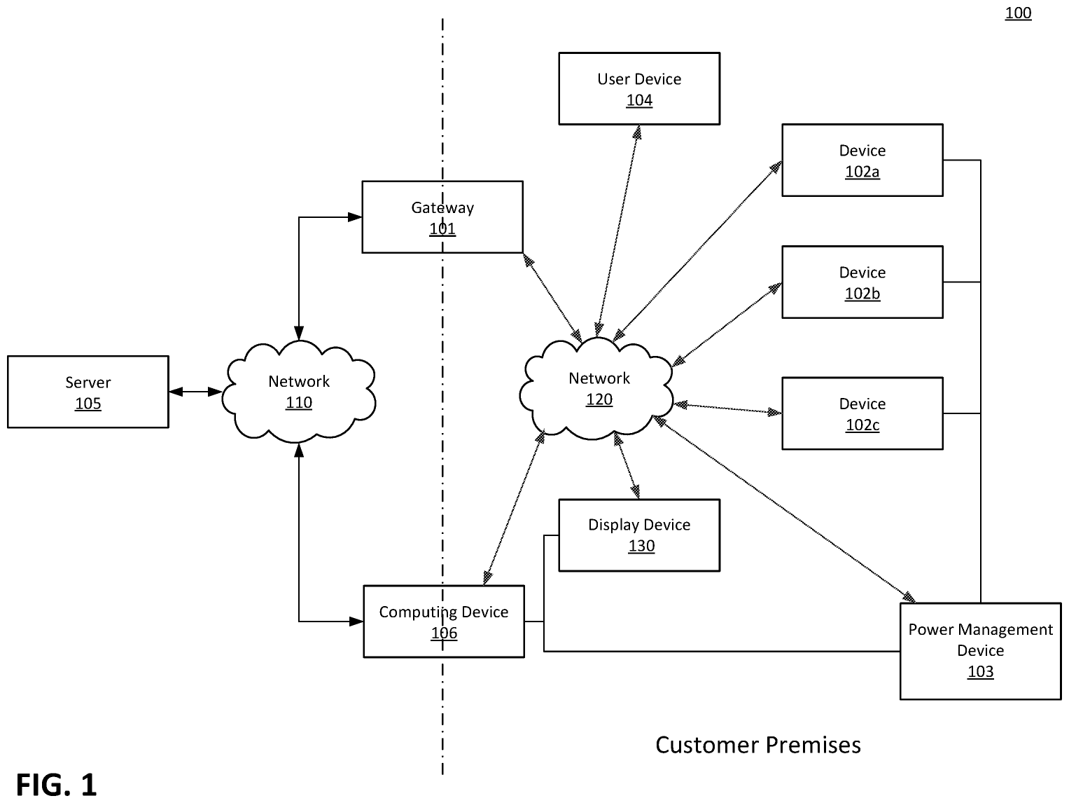

FIG. 1 shows an example system 100. The system 100 may comprise a gateway 101. The gateway 101 may operate as a wireless local area network (WLAN) router and cable modem. The gateway 101 may comprise transmitters, receivers, and/or transceivers for communicating via a network 120. The gateway 101 may store system information associated with a device 102a, a device 102b, and a device 102c. The gateway 101 may store the system information associated with the device 102a, the device 102b, and the device 102c in memory storage, a database, or in remote or cloud storage. The gateway 101 may execute an application providing a MIB browser used for sending SNMP messages to the device 102a, the device 102b, and the device 102c and for receiving SNMP messages from the device 102a, the device 102b, and the device 102c.

The network 120 may communicate using technologies such as WLAN technology based on the Institute of Electrical and Electronics Engineers (IEEE) 802.11 standard, wireless cellular technology, Bluetooth, coaxial cable, Ethernet, fiber optics, microwave, satellite, Public Switched Telephone Network (PTSN), Digital Subscriber Line (DSL), BPL, or any other appropriate technologies.

The gateway 101 may send signals, to a user device 104, via the network 120. The gateway 101 may receive signals, from the user device 104, via the network 120. The user device 104 may comprise, for example, a smartphone, a tablet, a laptop computer, a handheld computer, a desktop computer, or any other computing device capable of operating in the network 120. The user device 104 may comprise transmitters, receivers, and/or transceivers for communicating via the network 120. The user device 104 may send signals, to devices 102a, 102b, and 102c, via the network 120. The user device 104 may receive signals, from the devices 102a, 102b, and 102c, via the network 120. The user device 104 may store system information associated with the device 102a, the device 102b, and the device 102c. The user device 104 may store the system information associated with the device 102a, the device 102b, and the device 102c in memory storage, a database, or in remote or cloud storage. The user device 104 may execute an application providing a MIB browser used for sending SNMP messages to the device 102a, the device 102b, and the device 102c and for receiving SNMP messages from the device 102a, the device 102b, and the device 102c.

The devices 102a, 102b, and 102c may comprise transmitters, receivers, and/or transceivers for communicating via the network 120. The devices 102a, 102b, and 102c may comprise high inductive loads based on their motors generating alternating magnetic fields and consuming AC. The devices 102a, 102b, and 102c may each comprise an in-home smart appliance such as an air-conditioner, refrigerator, electric stove, dishwasher, oven, microwave, washing machine, or dryer capable of communicating with the network 120. The devices 102a, 102b, and 102c may each comprise a server, which may be associated with a content source, cable head end, or any other suitable system or other computing platform, capable of communicating with the network 120. The gateway 101 may send signals, to devices 102a, 102b, and 102c, via the network 120. The gateway 101 may receive signals, from the devices 102a, 102b, and 102c, via the network 120.

The gateway 101 may send signals, to a computing device 106, via the network 120. The gateway 101 may receive signals, from the computing device 106, via the network 120. The computing device 106 may comprise a set-top box, a wireless gateway, a desktop computer, a laptop computer, a handheld computer, a tablet, a netbook, a smartphone, a gaming console, or any other computing device capable of operating in the network 120. The computing device 106 may comprise transmitters, receivers, and/or transceivers for communicating via the network 120. The computing device 106 may send signals, to devices 102a, 102b, and 102c, via the network 120. The computing device 106 may receive signals, from the devices 102a, 102b, and 102c, via the network 120. The computing device 106 may send signals, to the user device 104, via the network 120. The computing device 106 may receive signals, from the user device 104, via the network 120. The computing device 106 may store system information associated with the device 102a, the device 102b, and the device 102c. The computing device 106 may store the system information associated with the device 102a, the device 102b, and the device 102c in memory storage, a database, or in remote or cloud storage. The computing device 106 may execute an application providing a MIB browser used for sending SNMP messages to the device 102a, the device 102b, and the device 102c and for receiving SNMP messages from the device 102a, the device 102b, and the device 102c.

The computing device 106 may be associated with a display device 130. The display device may be a television, a sound system, or monitor. The display device 130 may be capable of communicating with the network 120. The display device 130 may comprise transmitters, receivers, and/or transceivers for communicating via a network 120. The display device 130 may send signals, to devices 102a, 102b, and 102c, via the network 120. The display device 130 may receive signals, from the devices 102a, 102b, and 102c, via the network 120. The display device 130 may store system information associated with the device 102a, the device 102b, and the device 102c. The display device 130 may store the system information associated with the device 102a, the device 102b, and the device 102c in memory storage, a database, or in remote or cloud storage. The display device 130 may execute an application providing a MIB browser used for sending SNMP messages to the device 102a, the device 102b, and the device 102c and for receiving SNMP messages from the device 102a, the device 102b, and the device 102c.

A network 110 may comprise a network such as the Internet or any other network described herein. The gateway 101 may send signals, to a server 105, via the network 110. The gateway 101 may receive signals, from the server 105, via the network 110. The computing device 106 may send signals, to the server 105, via the network 110. The computing device 106 may receive signals, from the server 105, via the network 110. The user device 104 may send signals, to the server 105, via the network 110. The user device 104 may receive signals, from the server 105, via the network 110. The display device 130 may send signals, to the server 105, via the network 110. The display device 130 may receive signals, from the server 105, via the network 110.

The power management device 103 may comprise an electronic device capable of communicating with the network 120. The power management device 103 may comprise transmitters, receivers, and/or transceivers for communicating via a network 120. The power management device 103 may comprise a power source. The power source may comprise a capacitor bank or battery. The power management device 103 may comprise circuitry to allocate power from the power source to devices 102a, 102b, and 102c.

The gateway 101 may send signals, to the power management device 103, via the network 120. The gateway 101 may receive signals, from power management device 103, via the network 120. The computing device 106 may send signals, to the power management device 103, via the network 120. The computing device 106 may receive signals, from power management device 103, via the network 120. The user device 104 may send signals, to the power management device 103, via the network 120. The user device 104 may receive signals, from power management device 103, via the network 120. The display device 130 may send signals, to the power management device 103, via the network 120. The display device 130 may receive signals, from power management device 103, via the network 120. Alternatively or additionally, the power management device 103 may be embedded in gateway 101 or computing device 106.

The gateway 101 may send a signal to devices 102a, 102b, and 102c to request the operating status of devices 102a, 102b, or 102c. The devices 102a, 102b, or 102c may, for example, comprise smart appliances in a house or servers in a server farm. This signal may be sent periodically. The gateway 101 may send the signal using a MIB browser based on a user input. The signal sent may comprise an SNMP message. Alternatively or additionally, the signal may be sent periodically as a poll.

The gateway 101 may receive a signal comprising an indication of an operating mode of device 102a, 102b, or 102c. The received signal may have been sent in response to the request for operating status. The received signal may have been sent based on device 102a, 102b, or 102c entering a different operating mode. The received signal may comprise an SNMP message. The operating mode may indicate whether the device is going online or entering an operating mode using an increased or decreased power load. For example, if the device is a refrigerator, the device may indicate that the compressor is powering on.

The gateway 101 may retrieve operating mode data from the stored system information. The gateway 101 may retrieve the operating mode data associated with the device from the stored system information using the MAC address of the device. The gateway 101 may use the MAC address of the device to identify the device type of the device and retrieve, from the stored system information, the stored operating mode data (e.g. power load data, inductances, or capacitances) of that device type. The gateway 101 may determine a power load associated with the operating mode of the device using the operating mode data. The power load may indicate an inductive load. The operating mode data may comprise information to enable PFC of the system based on the operating mode of the device.

The gateway 101 may send an instruction to the power management device 103 to cause an allocation of power from a power source. The power management device 103 may comprise the power source, which may comprise a capacitor bank or battery. The power management device 103 may allocate power to the device. The power added to the system 100 from capacitor bank associated with the power management device 103 may perform PFC and reduce the reactive power in the system, and as a result, increase the power factor and efficiency of the system 100.

The computing device 106 may send a signal to devices 102a, 102b, and 102c to request the operating status of devices 102a, 102b, or 102c. The devices 102a, 102b, or 102c may, for example, comprise smart appliances in a house or servers in a server farm. This signal may be sent periodically. The computing device 106 may send the signal using a MIB browser based on a user input. The signal sent may comprise an SNMP message. Alternatively or additionally, the signal may be sent periodically as a poll.

The computing device 106 may receive a signal comprising an indication of an operating mode of device 102a, 102b, or 102c. The received signal may be in response to the request for operating status. The received signal may have been sent based on device 102a, 102b, or 102c entering a different operating mode. The received signal may comprise an SNMP message. The operating mode may indicate whether the device is going online or entering an operating mode using an increased or decreased power load. For example, if the device is a refrigerator, the device may indicate that the compressor is powering on.

The computing device 106 may retrieve operating mode data from the stored system information. The computing device 106 may retrieve the operating mode data associated with the device from the stored system information using the MAC address of the device. The computing device 106 may use the MAC address of the device to identify the device type of the device and retrieve, from the stored system information, the stored operating mode data (e.g. power load data, inductances, or capacitances) of that device type. The computing device 106 may determine a power load associated with the operating mode of the device using the operating mode data. The power load may indicate an inductive load. The operating mode data may comprise information to enable PFC of the system based on the operating mode of the device.

The computing device 106 may send an instruction to the power management device 103 to cause an allocation of power from a power source. The power management device 103 may comprise the power source, which may comprise a capacitor bank or battery. The power management device 103 may allocate power to the device. The power added to the system 100 from capacitor bank associated with the power management device 103 may perform PFC and reduce the reactive power in the system, and as a result, increase the power factor and efficiency of the system 100.

The user device 104 may send a signal to devices 102a, 102b, and 102c to request the operating status of devices 102a, 102b, or 102c. The devices 102a, 102b, or 102c may, for example, comprise smart appliances in a house or servers in a server farm. This signal may be sent periodically. The user device 104 may send the signal using a MIB browser based on a user input. The signal sent may comprise an SNMP message. Alternatively or additionally, the signal may be sent periodically as a poll.

The user device 104 may receive a signal comprising an indication of an operating mode of device 102a, 102b, or 102c. The received signal may be in response to the request for operating status. The received signal may have been sent based on device 102a, 102b, or 102c entering a different operating mode. The received signal may comprise an SNMP message. The operating mode may indicate whether the device is going online or entering an operating mode using an increased or decreased power load. For example, if the device is a refrigerator, the device may indicate that the compressor is powering on.

The user device 104 may retrieve operating mode data from the stored system information. The user device 104 may retrieve the operating mode data associated with the device from the stored system information using the MAC address of the device. The user device 104 may use the MAC address of the device to identify the device type of the device and retrieve, from the stored system information, the stored operating mode data (e.g. power load data, inductances, or capacitances) of that device type. The user device 104 may determine a power load associated with the operating mode of the device using the operating mode data. The power load may indicate an inductive load. The operating mode data may comprise information to enable PFC of the system based on the operating mode of the device.

The user device 104 may send an instruction to the power management device 103 to cause an allocation of power from a power source. The power management device 103 may comprise the power source, which may comprise a capacitor bank or battery. The power management device 103 may allocate power to the device. The power added to the system 100 from capacitor bank associated with the power management device 103 may perform PFC and reduce the reactive power in the system, and as a result, increase the power factor and efficiency of the system 100.

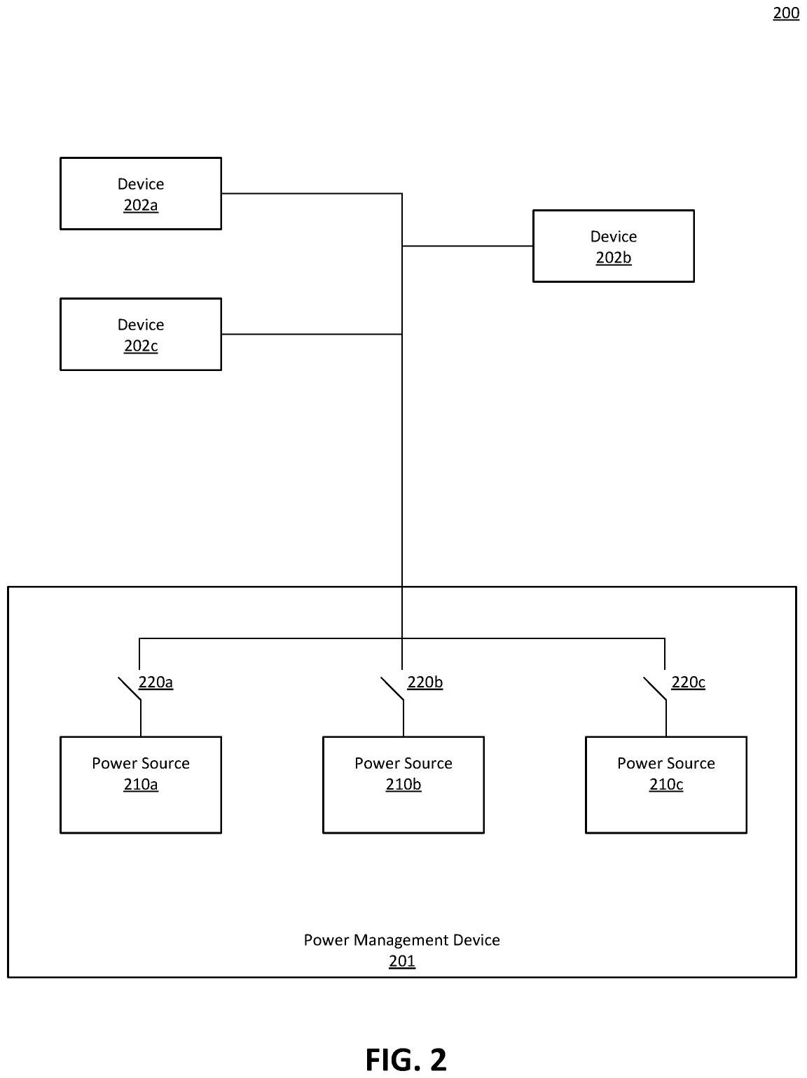

FIG. 2 shows an example system 200. The system 200 may comprise power management device 201 and devices 202a, 202b, and 202c. The devices 202a, 202b, and 202c may comprise any of the components and functionality described above with respect to the devices 102a, 102b, and 102c of FIG. 1. The power management device 201 may comprise the functionality and components described above with respect to the power management device 103 of FIG. 1.

The power management device 201 may comprise power sources 210a, 210b, and 210c. The power sources 210a, 210b, and 210c may comprise capacitor banks or batteries. The power management device 201 may comprise switches or relays 220a, 220b, and 220c. When relay 220a is switched closed, power from power source 210a is allocated to device 202a. When relay 220b is switched closed, power from power source 210b is allocated to device 202b. When relay 220c is switched closed, power from power source 210c is allocated to device 202c. The power management device 201 may receive an instruction from, the gateway 101, computing device 106, or user device 104 of FIG. 1, to allocate power from power source 210a, 210b, or 210c.

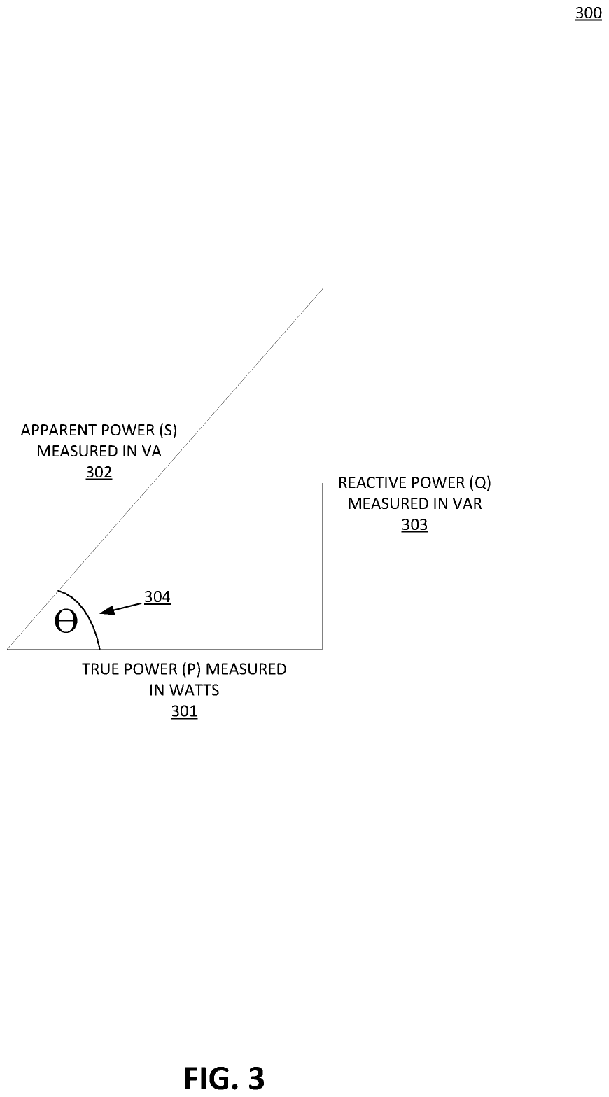

FIG. 3 shows an example power triangle 300. The power factor of FIG. 3 is the ratio between the useful or true power (P) measured in watts or kWs 301 to the total or apparent power measured in kVA 302 that is consumed by an item of AC electrical equipment or a complete electrical installation. As described above, power factor is a measure of how efficiently electrical power is converted into useful work output. The power management devices described herein may allocate power to a system in order to improve the power factor and system efficiency.

Power factor may be expressed as follows:

PF=kW÷kVA.

Power factor may alternatively be expressed, based on the angle θ 304, as follows:

cos θ=PF.

Apparent power in kVA may be expressed as follows:

kVA=\sqrt{kW²+kVAR²}.

Reactive power (Q) is measured in VAR 303. Reactive power may be expressed as follows:

kVAR=tan θ×kW.

The power management device 103 of FIG. 1 may be able to allocate power from a power source in order to reduce reactive power in the system. Reducing the reactive power in the system improves efficiency by increasing the power factor. Increasing the power factor so that it is closer to unity indicates improved efficiency.

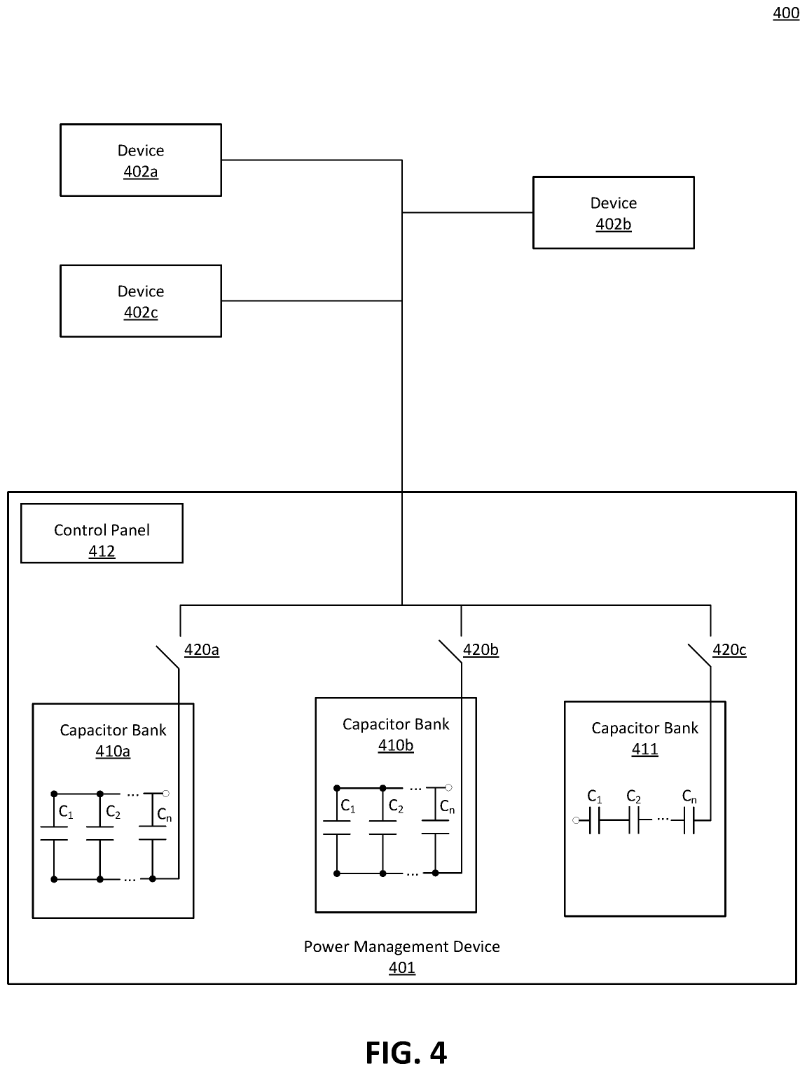

FIG. 4 shows an example system 400. The system 400 may comprise power management device 401 and devices 402a, 402b, and 402c. The devices 402a, 402b, and 402c may comprise any of the components and functionality described above with respect to the devices 102a, 102b, and 102c of FIG. 1. The power management device 401 may comprise the functionality and components the components and functionality described above with respect to the power management device 103 of FIG. 1.

The power management device 401 may comprise capacitor banks 410a, 410b, and 410c. The power management device 401 may comprise switches or relays 420a, 420b, and 420c. When relay 420a is switched closed, power from capacitor bank 410a is allocated to device 402a. When relay 420b is switched closed, power from capacitor bank 410b is allocated to device 402b. When relay 420c is switched closed, power from capacitor bank 411 is allocated to device 402c. The power management device 401 may comprise a control panel 412 that may display information associated with the capacitor banks 410a, 410b, and 410c. The information associated with the capacitor banks 410a, 410b, and 410c may indicate status information. The status information may indicate the capacitance of the capacitor banks 410a, 410b, and 410c that is available to allocate capacitance to the system. The power management device 401 may receive an instruction from, the gateway 101, computing device 106, or user device 104 of FIG. 1, to allocate power from power source 410a, 410b, or 410c.

Capacitor banks 410a and 410b may comprise a plurality of capacitors connected in parallel. When the capacitors are connected in parallel, their total equivalent capacitance is expressed as follows:

Cₜₒₜₐₗ=C₁+C₂+Cₙ₋₁Cₙ.

Capacitor bank 411 may comprise a plurality of capacitors connected in series. When the capacitors are connected in series, their total equivalent capacitance is expressed as follows:

1/Cₜₒₜₐᵢ=1/C₁+1/C₂+1/Cₙ₋₁+1/Cₙ.

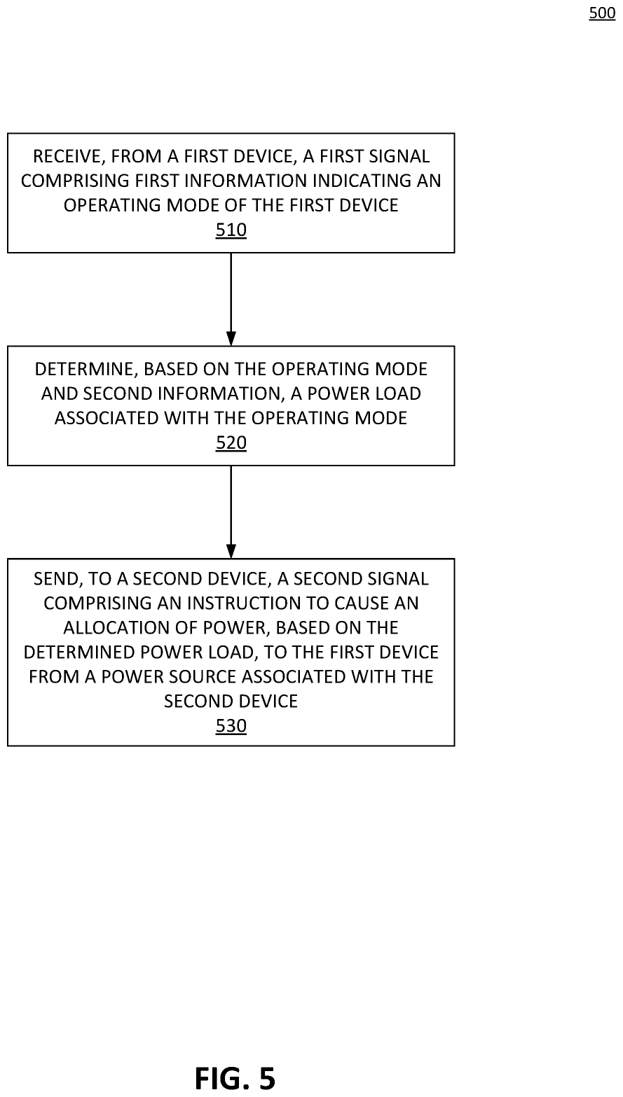

FIG. 5 shows an example method 500. The method 500 of FIG. 5, may be performed by the gateway 101, computing device 106, or user device 104 of FIG. 1. At step 510, a first signal comprising first information indicating an operating mode of the first device may be received from a first device. The first device may comprise a smart appliance. The first device may comprise a server in a server farm. The operating mode may indicate a status such as whether the first device is going online or entering a mode that requires an increased or decreased power load. The first signal may be received in response to a request for status that was sent to the first device. The first signal may comprise an SNMP message indicating the operating mode status of the first device. The first information indicating an operating mode may be displayed in a MIB browser of the gateway 101, computing device 106, or user device 104 of FIG. 1.

At step 520, a power load associated with the operating mode may be determined based on the operating mode and second information. The determined power load may comprise an increased or decreased power load. The determined power load may comprise an inductive load. The second information may comprise system information associated with the first device. Additionally, the second information may comprise system information associated with a plurality of devices operating in a system. The system information may be stored in memory storage, a database, or in remote or cloud storage. The gateway 101, computing device 106, or user device 104 of FIG. 1 may retrieve the system information from storage. The gateway 101, computing device 106, or user device 104 of FIG. 1 may receive the system information from another computing device, gateway, or user device. The system information may indicate operating mode data for the first device when operating at the indicated operating mode. The operating mode data may indicate the power load data of the first device when operating at the indicated operating mode. The operating mode data may comprise an inductance of the first device when operating at the indicated operating mode. The operating mode data may comprise a capacitance of the first device when operating at the indicated operating mode. The stored system information retrieved from the second information may be displayed in the MIB browser of the gateway 101, computing device 106, or user device 104 of FIG. 1.

At step 530, a second signal, may be sent to a second device, comprising an instruction to cause an allocation of power to the first device. The allocation of power may be based on the determined power load. The allocation of power may be from a power source associated with the second device. The second device may comprise the power management device 103 of FIG. 1. Alternatively of additionally, the power management device 103 may be embedded in the gateway 101 or computing device 106 of FIG. 1.

The allocation of power from the power source may comprise activating a switch to apply power from a capacitor bank or battery. The capacitor bank may supply capacitance to the system and reduce the reactive power in the system. The reduction of reactive power may increase the power factor of the system. An increased power factor indicates improved efficiency because more of the total power in the system is being used for work output in the system.

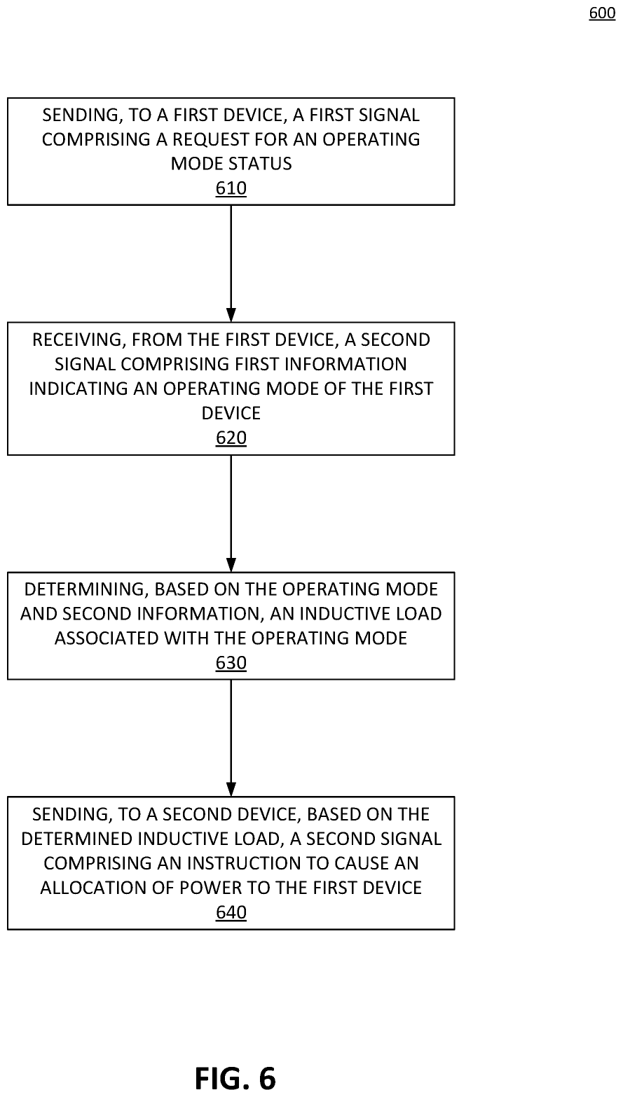

FIG. 6 shows an example method 600. The method 600 of FIG. 6, may be performed by the gateway 101, computing device 106, or user device 104 of FIG. 1. At step 610, a first signal comprising a request for an operating mode status may be sent to a first device. The first signal may comprise an SNMP message. The first signal may be sent based on a user input in a MIB browser of the gateway 101, computing device 106, or user device 104 of FIG. 1. The first device may comprise a smart appliance. The first device may comprise a server in a server farm.

At step 620, a second signal comprising first information indicating an operating mode of the first device may be received from the first device. The operating mode may indicate a status such as whether the first device is going online or entering a mode that requires an increased or decreased power load. The second signal may comprise an SNMP message indicating the operating mode status of the first device. The first information indicating an operating mode may be displayed in a MIB browser of the gateway 101, computing device 106, or user device 104 of FIG. 1.

At step 630, an inductive load associated with the operating mode may be determined based on the operating mode and second information. The second information may comprise system information associated with the first device. Additionally, the second information may comprise system information associated with a plurality of devices operating in a system. The system information may be stored in memory storage, a database, or in remote or cloud storage. The gateway 101, computing device 106, or user device 104 of FIG. 1 may retrieve the system information from storage. The gateway 101, computing device 106, or user device 104 of FIG. 1 may receive the system information from another computing device, gateway, or user device. The system information may indicate operating mode data comprising an inductance of the first device when operating at the indicated operating mode. The stored system information retrieved from the second information may be displayed in the MIB browser of the gateway 101, computing device 106, or user device 104 of FIG. 1.

At step 640, a second signal, may be sent to the first device, comprising an instruction to cause an allocation of power to the first device based on the determined inductive load. The allocation of power may be from a power source associated with a second device. The second device may comprise the power management device 103 of FIG. 1. Alternatively of additionally, the power management device 103 may be embedded in the gateway 101 or computing device 106 of FIG. 1.

The allocation of power from the power source may comprise activating a switch to apply power from a capacitor bank. The capacitor bank may supply capacitance to the system and reduce the reactive power in the system. The reduction of reactive power may increase the power factor of the system. An increased power factor indicates improved power efficiency because more of the total power is being used for work output in the system.

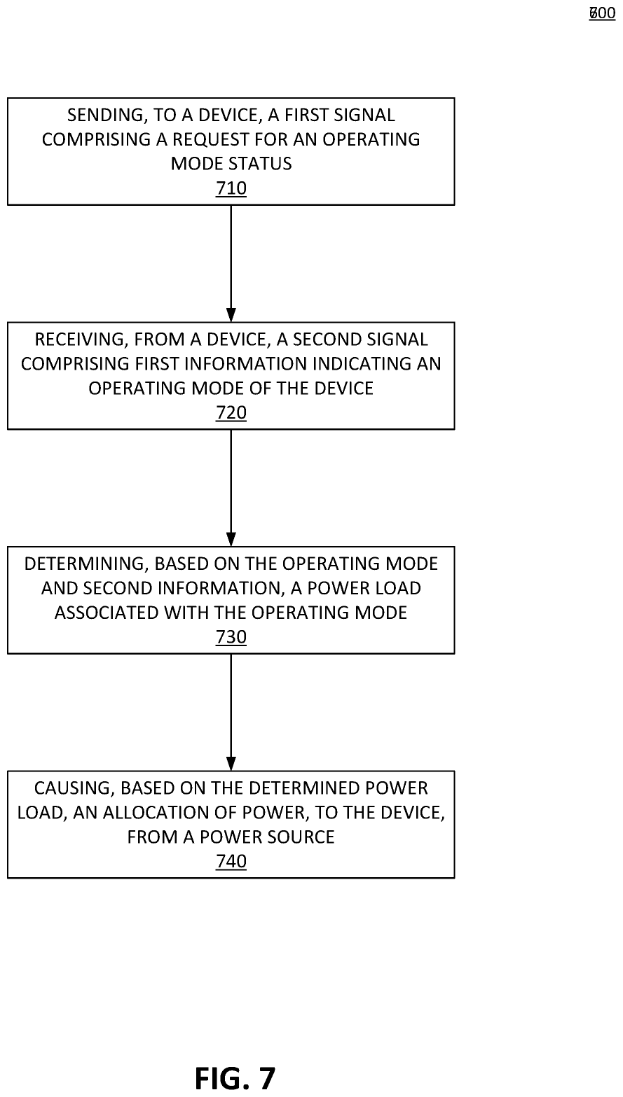

FIG. 7 shows an example method 700. The method 700 of FIG. 7, may be performed by the gateway 101, computing device 106, or user device 104 of FIG. 1. At step 710, a first signal comprising a request for an operating mode status may be sent to a device. The first signal may comprise an SNMP message. The first signal may be sent based on a user input in a MIB browser of the gateway 101, computing device 106, or user device 104 of FIG. 1. The device may comprise a smart appliance. The device may comprise a server in a server farm.

At step 720, a second signal comprising first information indicating an operating mode of the device may be received. The operating mode may indicate whether the device is going online or entering a mode that requires an increased or decreased power load. The second signal may comprise an SNMP message indicating the operating mode status of the device. The first information indicating an operating mode may be displayed in a MIB browser of the gateway 101, computing device 106, or user device 104 of FIG. 1.

At step 730, a power load associated with the operating mode may be determined based on the operating mode and second information. The determined power load may comprise an increased or decreased power load. The determined power load may comprise an inductive load. The second information may comprise system information associated with the device. Additionally, the second information may comprise system information associated with a plurality of devices operating in a system. The system information may be stored in memory storage, a database, or in remote or cloud storage. The gateway 101, computing device 106, or user device 104 of FIG. 1 may retrieve the system information from storage. The gateway 101, computing device 106, or user device 104 of FIG. 1 may receive the system information from another computing device, gateway, or user device. The system information may indicate operating mode data for the device operating at the indicated operating mode. The operating mode data may indicate the power load data of the device when operating at the indicated operating mode. The operating mode data may comprise an inductance of the device when operating at the indicated operating mode. The operating mode data may comprise a capacitance of the device when operating at the indicated operating mode. The second information retrieved from the stored system information may be displayed in the MIB browser of the gateway 101, computing device 106, or user device 104 of FIG. 1.

At step 740, an allocation of power to the device based on the determined power load may be caused. The allocation of power may be from a power source associated with a second device. The second device may comprise the power management device 103 of FIG. 1. Alternatively of additionally, the power management device 103 may be embedded in the gateway 101 or computing device 106 of FIG. 1.

The allocation of power from the power source may comprise activating a switch to apply power from a capacitor bank or battery. The capacitor bank may supply capacitance to the system and reduce the reactive power in the system. The reduction of reactive power may increase the power factor of the system. An increased power factor indicates improved power efficiency because more of the total power is being used for work output in the system.

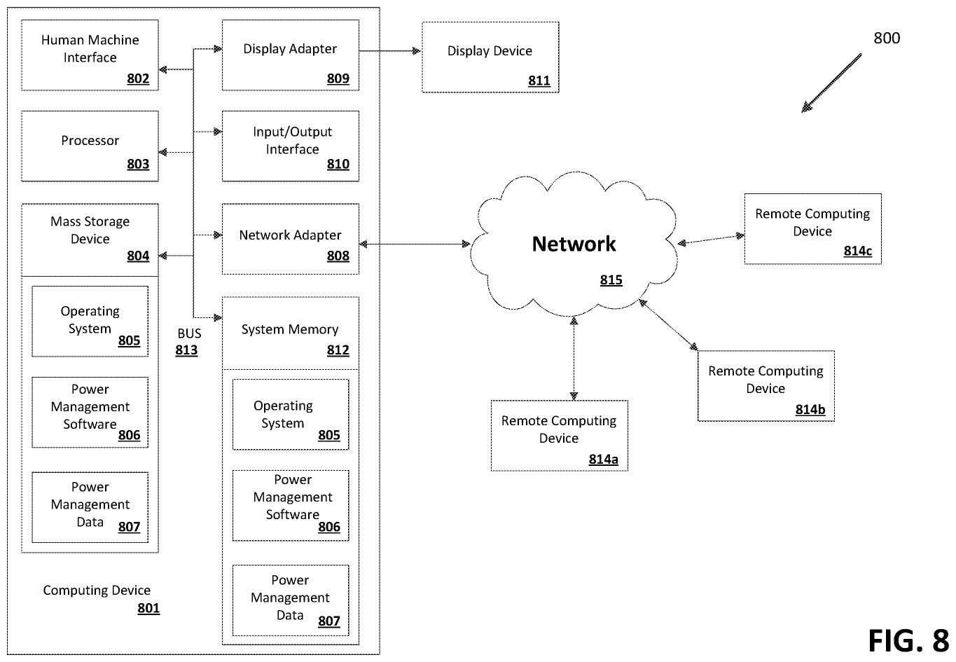

FIG. 8 shows an example operating environment 800. FIG. 8 is not intended to suggest any limitation as to the scope of use or functionality of operating environment architecture. Neither should the operating environment be interpreted as having any dependency or requirement relating to any one or combination of components shown in the example operating environment.

The disclosure described herein may be operational with numerous other general purpose or special purpose computing system environments or configurations. Computing systems, environments, and/or configurations that may be suitable for use with the systems and methods comprise, but are not limited to, personal computers, server computers, laptop devices, and multiprocessor systems. A computing system may comprise set top boxes, programmable consumer electronics, network PCs, minicomputers, mainframe computers, distributed computing environments that comprise any of the above systems or devices, and the like.

The processing described herein may be performed by software components. The present disclosure may be described in the general context of computer-executable instructions, such as program modules, being executed by one or more computers or other devices. Generally, program modules comprise computer code, routines, programs, objects, components, data structures, etc. that performs particular tasks or implements particular abstract data types. The present disclosure may be practiced in grid-based and distributed computing environments where tasks may be performed by remote processing devices that are linked through a communications network. In a distributed computing environment, program modules may be located in both local and remote computer storage media including memory storage devices.

A computing device 801 may be configured to implement the methods described herein. For example, the computing device 801 may perform any of the methods described herein. The methods of FIGS. 5-7 may be performed by one or more computing devices 801. The components of the computing device 801 may comprise, but are not limited to, one or more processors or processing units 803, a system memory 812, and a system bus 813 that couples various system components including the processor 803 to the system memory 812. In the case of multiple processing units 803, the system may utilize parallel computing.

The system bus 813 represents one or more of several possible types of bus structures, including a memory bus or memory controller, a peripheral bus, an accelerated graphics port, and a processor or a local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB), and/or the like. The bus 813, and all buses specified in this description may be implemented over a wired or wireless network connection and each of the subsystems, including the processor 803, a mass storage device 804, an operating system 805, power management software 806, power management data 807, a network adapter 808, system memory 812, an Input/Output Interface 810, a display adapter 809, a display device 811, and a human machine interface 802, may be contained within one or more remote computing devices 814a,b,c at physically separate locations, connected through buses of this form, in effect implementing a fully distributed system.

The computing device 801 typically comprises a variety of computer readable media. Example readable media may be any available media that is accessible by the computing device 801 and may comprise both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as power management data 807 and/or program modules such as operating system 805 and power management software 806 that are immediately accessible to and/or are presently operated on by the processing unit 803. The power management data 807 may comprise system information comprising the inductances of various devices at various modes of operation.

The computing device 801 may comprise other removable/non-removable, volatile/non-volatile computer storage media. By way of example, FIG. 8 shows a mass storage device 804 that may provide non-volatile storage of computer code, computer readable instructions, data structures, program modules, and other data for the computing device 801. A mass storage device 804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 804, including by way of example, an operating system 805 and the power management software 806. Each of the operating system 805 and the power management software 806 (or some combination thereof) may comprise elements of the programming and the power management software 806. The power management data 807 may be stored on the mass storage device 804. The power management data 807 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

A user may enter commands and information into the computing device 801 via an input device (not shown). Examples of such input devices may comprise, but are not limited to, a keyboard, a pointing device (e.g., a “mouse”), a microphone, a joystick, a scanner, tactile input devices such as gloves, and other body coverings, and the like. These and other input devices may be connected to the processing unit 803 via the human machine interface 802 that is coupled to the system bus 813, but may be connected by other interface and bus structures, such as a parallel port, game port, an IEEE 1394 Port (also known as a Firewire port), a serial port, or a universal serial bus (USB).

The display device 811 may be connected to the system bus 813 via an interface, such as the display adapter 809. It is contemplated that the computing device 801 may have more than one display adapter 809 and the computer 801 may have more than one display device 811. A display device may comprise a monitor, an LCD (Liquid Crystal Display), or a projector. The display device 811 and/or other output peripheral devices may comprise components such as speakers (not shown) and a printer (not shown) which may be connected to the computing device 801 via the Input/Output Interface 810. Any step and/or result of the methods may be output in any form to an output device. Such output may comprise any form of visual representation, including, but not limited to, textual, graphical, animation, audio, tactile, and the like. The display device 811 and computing device 801 may comprise part of one device, or separate devices.

The computing device 801 may operate in a networked environment using logical connections to one or more remote computing devices 814a,b,c. By way of example, a remote computing device may comprise a personal computer, portable computer, a smart phone, a server, a router, a network computer, a peer device or other common network node. Logical connections between the computing device 801 and a remote computing device 814a,b,c may be made via a network 815, such as a local area network (LAN) and a general wide area network (WAN). Such network connections may be through the network adapter 808. The network adapter 808 may be implemented in both wired and wireless environments. Such networking environments are conventional and commonplace in dwellings, offices, enterprise-wide computer networks, intranets, and the Internet.

For purposes of explanation, application programs and other executable program components such as the operating system 805 are shown herein as discrete blocks, although such programs and components may reside at various times in different storage components of the computing device 801, and may be executed by the data processor(s) of the computer. An implementation of the power management software 806 may be stored on or sent across some form of computer readable media. Any of the disclosed methods may be performed by computer readable instructions embodied on computer readable media. Computer readable media may comprise any available media that may be accessed by a computer. By way of example and not limitation, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

1. A method comprising:
receiving, from a first device, a first signal comprising first information indicating an operating mode of the first device;
determining, based on the operating mode and second information, a power load associated with the operating mode; and
sending, to a second device, a second signal comprising an instruction to cause an allocation of power, based on the determined power load, to the first device from a power source associated with the second device.

2. The method of claim 1, wherein receiving the first signal comprises receiving the first signal in response to a status request message.

3. The method of claim 1, further comprising:
receiving, from a computing device, the second information.

4. The method of claim 1, wherein the second information comprises system information associated with a device type associated with the first device.

5. The method of claim 4, wherein the system information comprises operating mode data for the device type to enable power factor correction.

6. The method of claim 1, wherein the power load comprises an inductive load.

7. The method of claim 1, wherein the power source comprises a capacitor bank.

8. The method of claim 1, further comprising:
sending, to the first device, a third signal comprising a request for a medium access control (MAC) address associated with the first device;
receiving, from the first device, a fourth signal comprising the requested MAC address; and
determining, based on the requested MAC address and the second information, a device type associated with the first device.

9. The method of claim 1, wherein the first device comprises a household appliance.

10. A method comprising:
sending, to a first device, a first signal comprising a request for an operating mode status;
receiving, from the first device, a second signal comprising first information indicating an operating mode of the first device;
determining, based on the operating mode and second information, an inductive load associated with the operating mode; and
sending, to a second device, based on the determined inductive load, a second signal comprising an instruction to cause an allocation of power to the first device.

11. The method of claim 10, further comprising:
receiving, from a computing device, the second information.

12. The method of claim 10, wherein the second information comprises system information associated with a device type associated with the first device.

13. The method of claim 12, wherein the system information comprises operating mode data for the device type to enable power factor correction.

14. The method of claim 10, wherein the allocation of power comprises an allocation of capacitance from a capacitor bank.

15. The method of claim 10, further comprising:
sending, to the first device, a third signal comprising a request for a medium access control (MAC) address associated with the first device;
receiving, from the first device, a fourth signal comprising the requested MAC address; and
determining, based on the requested MAC address and the second information, a device type associated with the first device.

16. The method of claim 10, wherein the first device comprises a household appliance.

17. A method comprising:
sending, to a device, a first signal comprising a request for an operating mode status;
receiving, from a device, a second signal comprising first information indicating an operating mode of the device;
determining, based on the operating mode and second information, a power load associated with the operating mode; and
causing, based on the determined power load, an allocation of power, to the device, from a power source.

18. The method of claim 17, wherein the second information comprises system information associated with a device type associated with the device.

19. The method of claim 18, wherein the system information comprises operating mode data for the device type to enable power factor correction.

20. The method of claim 17, further comprising:
receiving, from a computing device, the second information.
